(19) United States
(12) Patent Application Publication
(10) Pub. No.: US 2026/0089534 A1
(43) Pub. Date: Mar. 26, 2026

(54) METHODS AND APPARATUSES FOR MULTI-PATH TRANSMISSION

(71) Applicant: Lenovo (Beijing) Limited, Beijing (CN)

(72) Inventors: Ran Yue, Beijing (CN); Lianhai Wu, Beijing (CN); Jing Han, Beijing (CN); Haiming Wang, Beijing (CN); Min Xu, Beijing (CN); Jie Hu, Beijing (CN)

(73) Assignee: Lenovo (Beijing) Limited, Beijing (CN)

(21) Appl. No.: 19/112,538

(22) PCT Filed: Sep. 28, 2022
(86) PCT No.: PCT/CN2022/122276

§ 371 Date: Mar. 17, 2025

(51) Int. Cl. H04W 24/10; H04W 76/15; H04W 88/04

(52) U.S. Cl. CPC H04W 24/10; H04W 76/15; H04W 88/04

(57) ABSTRACT

Embodiments of the present application are related to methods and apparatuses for multi-path transmission. An embodiment of the present application provides a user equipment (UE) including: a transceiver configured to receive one or more information reports about one or more relay nodes from a base station (BS) or the one or more relay nodes; and a processor coupled to the transceiver and configured to: select at least one path for data transmission from two or more paths between the UE and the BS based at least in part on the obtained one or more information reports, wherein the two or more paths include one or more indirect paths corresponding to the one or more relay nodes and at least one direct path between the UE and the BS.

### TECHNICAL FIELD

The present disclosure generally relates to wireless communications, and especially to multi-path (also referred to as multiple paths or MP) transmission.

### BACKGROUND OF THE INVENTION

When multi-path relaying is configured, user data traffic from/to a user equipment (UE) can select one or the other of two paths for data transmission, e.g., based on link quality without radio resource control (RRC) reconfiguration. Moreover, a multi-path split bearer may be supported in the network, i.e., a bearer may be mapped to both paths based on the existing split bearer framework.

In legacy, a data volume is specified to trigger the path selection for data transmission. The reference signal received power (RSRP) of the primary radio link control (RLC) entity and the split secondary RLC entity(ies) can be used in order to select the path to transmit a packet data convergence protocol (PDCP) protocol data unit (PDU) from the perspective of implementation. The primary RLC entity and the split secondary RLC entity(ies) are all direct paths and the UE obtains the channel quality by itself. However, the UE has no idea on the channel quality of the Uu link between a relay node and a base station (BS) when multi-path is configured in the scenario of sidelink relay. Therefore, new designs are desired for implementing the path selection in such scenario.

### SUMMARY

Some embodiments of the present disclosure provide a UE including: a transceiver configured to receive one or more information reports about one or more relay nodes from a BS or the one or more relay nodes; and a processor coupled to the transceiver and configured to: select at least one path for data transmission from two or more paths between the UE and the BS based at least in part on the obtained one or more information reports, wherein the two or more paths include one or more indirect paths corresponding to the one or more relay nodes and at least one direct path between the UE and the BS.

In some embodiments, the processor is configured to select the at least one path for data transmission when a first condition is fulfilled, wherein the first condition includes at least one of the following: a data volume pending for transmission being equal to or larger than a selection triggering threshold; the data volume pending for transmission being equal to or larger than an information request threshold; a channel quality of a current activated path being equal to or lower than a first channel quality threshold; or a channel quality deterioration of the current activated path being larger than a channel quality variation threshold.

In some embodiments, the selection triggering threshold, the information request threshold, the first channel quality threshold, or the channel quality variation threshold is configured by the BS or the one or more relay nodes.

In some embodiments, the transceiver is further configured to: transmit an information request to the BS or the one or more relay nodes when the first condition is fulfilled, wherein the one or more information reports are received in response to the information request.

In some embodiments, the transceiver is configured to receive the one or more information reports periodically and/or for a predefined or preconfigured number of times in response to the information request.

In some embodiments, the information request is transmitted via an RRC message, information element (IE), medium access control (MAC) control element (CE), or uplink control information (UCI).

In some embodiments, the transceiver is further configured to transmit a report ending indication to the BS or to the one or more relay nodes for indicating to stop transmission of the one or more information reports about the one or more relay nodes.

In some embodiments, the report ending indication is transmitted via an RRC message, IE, MAC CE, or UCI.

In some embodiments, the transceiver is further configured to transmit at least one of the following thresholds to each relay node of the one or more relay nodes for triggering the relay node to transmit an information report about the relay node when a second condition is fulfilled: a second channel quality threshold; one or more load thresholds; or one or more power consumption thresholds.

In some embodiments, the second condition includes at least one of the following: a channel quality of a Uu link between the relay node and the BS being lower than or higher than the second channel quality threshold; a load on the Uu link being equal to or higher than at least one of the one or more load thresholds; or a power consumption of the relay node being equal to or higher than at least one of the one or more power consumption thresholds.

In some embodiments, each of the one or more information reports includes at least one of: a channel quality of a Uu link between an associated relay node and the BS; a channel quality indication for indicating whether the channel quality of the Uu link is lower than or higher than a second channel quality threshold; a load on the Uu link; a load indication for indicating whether the load on the Uu link is lower than, equal to, or higher than at least one load threshold; a power consumption of the associated relay node; or a power consumption indication for indicating whether the power consumption of the associated relay node is lower than, equal to, or higher than at least one power consumption threshold.

In some embodiments, to select the at least one path from the two or more paths, the processor is further configured to: determine, for each relay node of the one or more relay nodes, a minimum channel quality of a channel quality of a Uu link between the relay node and the BS and a channel quality of a sidelink between the relay node and the UE to be a channel quality of an indirect path corresponding to the relay node; and select the at least one path from the two or more paths according to at least one of: a channel quality of the at least one direct path and one or more minimum channel qualities of the one or more relay nodes; one or more loads of the one or more relay nodes; or one or more power consumptions of the one or more relay nodes.

In some embodiments, the processor is configured to select the at least one path with the best channel quality(ies).

In some embodiments, to select the at least one path from the two or more paths, the processor is further configured to: select relay node(s) from the one or more relay nodes, wherein for each of the selected relay node(s), a sidelink channel quality of the selected relay node is higher than a sidelink channel quality threshold, and a Uu link channel quality of the selected relay node is higher than a Uu channel quality threshold; determine channel quality(ies) for selected indirect path(s) corresponding to the selected relay node(s) based on the sidelink channel quality(ies) and the Uu link channel quality(ies) of the selected relay node(s); and select the at least one path from the two or more paths according to at least one of: channel quality(ies) of the selected indirect path(s) and a channel quality of the at least one direct path; load(s) of the selected relay node(s); or power consumption(s) of the selected relay node(s).

In some embodiments, the sidelink channel quality threshold and the Uu channel quality threshold are configured or predefined.

In some embodiments, to select the at least one path from the two or more paths, the processor is further configured to: select relay node(s) from the one or more relay nodes, wherein for each of the selected relay node(s), a sidelink channel quality of the selected relay node is higher than a sidelink channel quality threshold; determine the Uu link channel quality(ies) of the selected relay node(s) to be channel quality(ies) of selected indirect path(s) corresponding to the selected relay node(s); and select the at least one path from the two or more paths according to at least one of: channel quality(ies) of the selected indirect path(s) and a channel quality of the at least one direct path; load(s) of the selected relay node(s); or power consumption(s) of the selected relay node(s).

In some embodiments, to select the at least one path from the two or more paths, the processor is further configured to: determine, for each relay node of the one or more relay node, a channel quality average of a channel quality of a sidelink between the relay node and the UE and a channel quality of a Uu link between the relay node and the BS; select the at least one path from the two or more paths according to at least one of: one or more channel quality averages of the one or more relay nodes and a channel quality of the at least one direct path; one or more loads of the one or more relay; or one or more power consumptions of the one or more relay nodes.

In some embodiments, the channel quality average is a moving average or an arithmetic means.

In some embodiments, a number of the at least one path selected for data transmission is configured, indicated by a network, or predefined.

Some embodiments of the present disclosure provide a BS including: a transceiver configured to: transmit an information report about a relay node to a UE for the UE to select at least one path for data transmission from two or more paths between the UE and the BS; and a processor coupled to the transceiver, wherein the two or more paths includes an indirect path corresponding to the relay node and at least one direct path between the UE and the BS.

In some embodiments, the transceiver is further configured to transmit at least one of the following thresholds to the UE for triggering the UE to select the at least one path for data transmission from the two or more paths when a first condition is fulfilled: a selection triggering threshold; an information request threshold; a first channel quality threshold; or a channel quality variation threshold.

In some embodiments, the first condition includes at least one of the following: a data volume pending for transmission at the UE being equal to or larger than the selection triggering threshold; the data volume pending for transmission at the UE being equal to or larger than the information request threshold; a channel quality of a current activated path being equal to or lower than the first channel quality threshold; or a channel quality deterioration of the current activated path being larger than the channel quality variation threshold.

In some embodiments, the transceiver is further configured to: receive an information request from the UE; and transmit the information report to the UE in response to the information request.

In some embodiments, the transceiver is configured to transmit the information report to the UE periodically and/or for a predefined or preconfigured number of times after receiving the information request.

In some embodiments, the information request is received via an RRC message, IE, MAC CE, or UCI.

In some embodiments, the transceiver is further configured to receive a report ending indication from the UE for indicating to stop transmission of the information report about the relay node.

In some embodiments, the report ending indication is received via an RRC message, IE, MAC CE, or UCI.

In some embodiments, the transceiver is further configured to transmit at least one of the following thresholds to the relay node for triggering the relay node to transmit an information report about the relay node when a second condition is fulfilled: a second channel quality threshold; one or more load thresholds; or one or more power consumption thresholds.

In some embodiments, the second condition includes at least one of the following: a channel quality of a Uu link between the relay node and the BS being lower than or higher than the second channel quality threshold; a load on the Uu link being equal to or higher than at least one of the one or more load thresholds; or a power consumption of the relay node being equal to or higher than at least one of the one or more power consumption thresholds.

In some embodiments, the information report includes at least one of: a channel quality of a Uu link between the relay node and the BS; a channel quality indication for indicating whether the channel quality of the Uu link is lower than or higher than a second channel quality threshold; a load on the Uu link; a load indication for indicating whether the load on the Uu link is lower than, equal to, or higher than at least one load threshold; a power consumption of the relay node; or a power consumption indication for indicating whether the power consumption of the relay node is lower than, equal to, or higher than at least one power consumption threshold.

In some embodiments, the transceiver is configured to transmit the information report when a second condition is fulfilled, wherein the second condition includes at least one of the following: a channel quality of a Uu link between the relay node and the BS being lower than or higher than a second channel quality threshold; a load on the Uu link being equal to or higher than at least one load threshold; or a power consumption of the relay node being equal to or higher than at least one power consumption threshold.

In some embodiments, the transceiver is configured to transmit the information report to the UE periodically and/or for a predefined or preconfigured number of times after the second condition is fulfilled.

In some embodiments, the transceiver is further configured to receive the information report from the relay node.

In some embodiments, the transceiver is further configured to transmit at least one of a sidelink channel quality threshold or a Uu channel quality threshold to the UE for selecting the at least one path from the two or more paths.

In some embodiments, the transceiver is further configured to transmit a number of the at least one path selected for data transmission to the UE.

Some embodiments of the present disclosure provide a relay node including: a transceiver configured to: transmit an information report about the relay node for a UE to select at least one path for data transmission from two or more paths between the UE and a BS; and a processor coupled to the transceiver, wherein the two or more paths include an indirect path corresponding to the relay node and at least one direct path between the UE and the BS.

In some embodiments, the transceiver is further configured to: receive an information request from the UE; and transmit the information report to the UE in response to the information request.

In some embodiments, the transceiver is configured to transmit the information report to the UE periodically and/or for a predefined or preconfigured number of times after receiving the information request.

In some embodiments, the information request is received via an RRC message, IE, MAC CE, or UCI.

In some embodiments, the transceiver is further configured to receive a report ending indication from the UE for indicating to stop transmission of the information report.

In some embodiments, the report ending indication is received via an RRC message, IE, MAC CE, or UCI.

In some embodiments, the transceiver is configured to transmit the information report when a condition is fulfilled, wherein the condition includes at least one of the following: a channel quality of a Uu link between the relay node and the BS being lower than or higher than a channel quality threshold; a load on the Uu link being equal to or higher than at least one load threshold; or a power consumption of the relay node being equal to or higher than at least one power consumption threshold.

In some embodiments, the transceiver is further configured to receive at least one of the channel quality threshold, the at least one load threshold, or the at least power consumption threshold from the BS or the UE.

In some embodiments, the transceiver is configured to transmit the information report periodically or for a predefined or preconfigured number of times after the condition is fulfilled.

In some embodiments, the information report includes at least one of: a channel quality of a Uu link between the relay node and the BS; a channel quality indication for indicating whether the channel quality of the Uu link is lower than or higher than a channel quality threshold; a load on the Uu link; a load indication for indicating whether the load on the Uu link is lower than, equal to, or higher than at least one load threshold; a power consumption of the relay node; or a power consumption indication for indicating whether the power consumption of the relay node is lower than, equal to, or higher than at least one power consumption threshold.

Some embodiments of the present disclosure provide a method performed by a UE. The method includes: receiving one or more information reports about one or more relay nodes from a BS or the one or more relay node; and selecting at least one path for data transmission from two or more paths between the UE and the BS based at least in part on the obtained one or more information reports, wherein the two or more paths include one or more indirect paths corresponding to the one or more relay nodes and at least one direct path between the UE and the BS.

Some embodiments of the present disclosure provide a method performed by a BS. The method includes: transmitting an information report about a relay node to a UE for the UE to select at least one path for data transmission from two or more paths between the UE and the BS, wherein the two or more paths includes an indirect path corresponding to the relay node and at least one direct path between the UE and the BS.

Some embodiments of the present disclosure provide a method performed by a relay node. The method includes: transmitting an information report about the relay node for a UE to select at least one path for data transmission from two or more paths between the UE and a BS, wherein the two or more paths include an indirect path corresponding to the relay node and at least one direct path between the UE and the BS.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method performed by a UE according to some embodiments of the present disclosure.

FIG. 3 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 is a schematic diagram illustrating an exemplary wireless communication system 100 according to some embodiments of the present disclosure.

As shown in FIG. 1, the wireless communication system 100 includes at least one BS 101, at least one UE 102, and at least one relay node 103. Although one BS, one UE, and one relay node are depicted in FIG. 1 for illustrative purpose, it is contemplated that any number of BSs, UEs, and relay nodes may be included in the wireless communication system 100.

The wireless communication system 100 is compatible with any type of network that supports MP split bearer. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a radio access network (RAN) node, a next generation (NG) RAN node, a node-B, an enhanced node B (eNB), a gNB, a home node-B, or a device, or described using other terminology used in the art. The BS 101 is generally part of a RAN that may include a controller communicably coupled to the BS 101.

According to some embodiments of the present application, the UE 102 may be a vehicle UE (VUE) and/or power-saving UE (also referred to as power sensitive UE). The power-saving UE may include vulnerable road users (VRU), public safety UE (PS-UE), and/or commercial sidelink UE (CS-UE) that are sensitive to power consumption. In an embodiment of the present application, a VRU may be a pedestrian UE (P-UE), a cyclist UE, a wheelchair UE or any UE which requires power saving compared with a VUE.

According to some other embodiments of the present application, the UE 102 may be a computing device, such as desktop computer, laptop computer, personal digital assistant (PDA), tablet computer, smart television (e.g., televisions connected to the Internet), set-top box, game console, security system (or security camera), vehicle on-board computer, network device (e.g., router, switch, and modem), or the like.

According to some other embodiments of the present application, the UE 102 may be a portable wireless communication device, smart phone, cellular telephone, flip phone, device having a subscriber identity module, personal computer, selective call receiver, or any device that is capable of sending and receiving communication signals on a wireless network.

According to some other embodiments of the present application, the UE 102 may be a wearable device, such as smart watches, fitness band, optical head-mounted display, or the like.

Moreover, the UE 102 may be referred to as a subscriber unit, mobile, mobile station, user, terminal, mobile terminal, wireless terminal, fixed terminal, subscriber station, user terminal, or device, or described using other terminology used in the art.

In the example shown in FIG. 1, the UE 102 may directly communicate with the BS 101 via a Uu link. The UE 102 also may communicate with the BS 101 via the relay node 103 (e.g., another UE inside coverage of the BS 101). That is, there are two paths between the UE 102 and the BS 101. The first path is a direct path which includes the Uu link between the UE 102 and the BS 101. The second path is an indirect path which includes part 1 and part 2, wherein the part 1 is the Uu link between the BS 101 and the relay node 103, and the part 2 is the sidelink (SL) link (also referred to as PC-5 or PC5 link) between the relay node 103 and the UE 102. The UE 102 communicating with the BS 101 via the relay node 103 can be referred to as a remote UE. Although only one indirect path and only one direct path are depicted in FIG. 1 for illustrative purpose, it is contemplated that any number of indirect paths or any number of direct paths may be included in the wireless communication system 100, and each indirect path may include or correspond to one or more relay nodes. The UE 102 may select one or more of the direct and indirect paths for data transmission between the UE 102 and the BS 101.

Current designs for path selection for a multi-path split bearer do not consider indirect path(s) associated with or corresponding to relay node(s). If the path selection involves an indirect path associated with a relay node, the UE needs to know the channel quality of the Uu link between the relay node and the BS. In addition, it is not optimal to always enable a relay node to send its Uu RSRP to the UE.

Moreover, both the channel quality of a Uu link and the channel quality of a PC-5 link are involved on an indirect path, while only a Uu link is involved on the direct path. How to compare the channel quality of the indirect path and that of the direct path to select a path for data transmission also needs to be considered.

The present disclosure at least provides various solutions for transmission with split bearer in a multi-path scenario, including but not limited to triggering to obtain information (such as channel quality, load, power consumption) of one or more relay nodes (or one or more indirect paths, or one or more Uu links of the one or more indirect paths), selecting at least one path from one or more indirect paths and at least one direct path for data transmission based at least in part on the obtained information, etc.

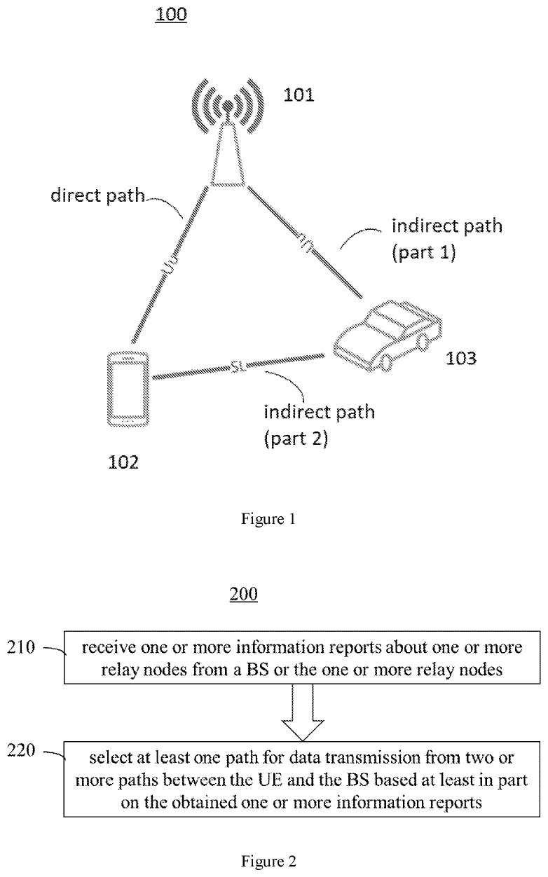

FIG. 2 illustrates an exemplary method 200 performed by a UE (e.g., UE 102 in FIG. 1) according to some embodiments of the present disclosure. The UE may support a multi-path split bearer. There are two or more paths between the UE and a BS (e.g., BS 101 in FIG. 1). The two or more paths may include one or more indirect paths corresponding to one or more relay nodes (e.g., relay node 103 in FIG. 1) and at least one direct path between the UE and the BS. It is contemplated that the method 200 may also be performed by other devices with similar functions. The embodiments of FIG. 2 described below may involve some operations performed at other devices (e.g., BS, or relay node), which are only for purpose of illustration and not intended to limit the operations performed by the UE.

In step 210, the UE may receive one or more information reports about the one or more relay nodes. The one or more information reports may be received from the BS (e.g., via the Uu link between the UE and the BS) or the one or more relay nodes (e.g., via the sidelink(s) between the UE and the relay node(s)). In some embodiments, the one or more relay nodes may transmit their information reports to the BS, and then the BS may transmit these information reports to the UE.

In some embodiments, each of the one or more information reports about the one or more relay nodes is associated with one of the relay nodes and includes at least one of:
a channel quality of a Uu link between the associated relay node and the BS: for example, the channel quality may include an RSRP or reference signal received quality (RSRQ) measurement result;
a channel quality indication for indicating whether the channel quality of the Uu link is lower than or higher than a channel quality threshold Q1 or whether the channel quality of the Uu link is good (e.g., the channel quality is higher than Q1) or bad (e.g., the channel quality is low than Q1):
for example, the channel quality indication may be a 1-bit indication, where the indication being “1” may indicate that the channel quality of the Uu link is higher than or equal to Q1 or the channel quality of the Uu link is good, and the indication being “0” may indicate that the channel quality of the Uu link is lower than Q1 or the channel quality of the Uu link is bad, or vice versa;
a load on the Uu link;
a load indication for indicating whether the load on the Uu link is lower than, equal to, or higher than one or more load thresholds or whether the load on the Uu link is low, medium, or high:
for example, assuming that there is only one load threshold L, the load indication may be a 1-bit indication, where the indication being “1” may indicate that the load on the Uu link is higher than or equal to L or the load on the Uu link is high, and the indication being “0” may indicate that the load on the Uu link is lower than L or the load on the Uu link is low, or vice versa; assuming that there are two load thresholds L1 and L2 (L2>L1), the load indication may be a 2-bit indication, where the indication being “00” may indicate that the load on the Uu link is lower than L1 or the load on the Uu link is low, the indication being “01” may indicate that the load on the Uu link is equal to or higher than L1 but lower than L2 or the load on the Uu link is medium, and the indication being “10” may indicate that the load on the Uu link is equal to or higher than L2 or the load on the Uu link is high;
a power consumption of the associated relay node; or
a power consumption indication for indicating whether the power consumption of the associated relay node is lower than, equal to, or higher than one or more power consumption thresholds or whether the power consumption of the associated relay node is low, medium, or high:
for example, assuming that there is only one power consumption threshold P, the power consumption indication may be a 1-bit indication, where the indication being “1” may indicate that the power consumption of the associated relay node is higher than or equal to P or the power consumption of the associated relay node is high, and the indication being “0” may indicate that the power consumption of the associated relay node is lower than P or the power consumption of the associated relay node is low, or vice versa; assuming that there are power consumption thresholds P1 and P2 (P2>P1), the power consumption indication may be a 2-bit indication, where the indication being “00” may indicate that the power consumption of the relay node is lower than P1 or the power consumption of the relay node is low, the indication being “01” may indicate that the power consumption of the relay node is equal to or higher than P1 but lower than P2 or the power consumption of the relay node is medium, the indication being “10” may indicate that the power consumption of the relay node is equal to or higher than P2 or the power consumption of the relay node is high.

In some embodiments, at least one of the aforementioned channel quality threshold Q1, the one or more load thresholds, or the one or more power consumption thresholds may be configured to the relay node by the UE via the sidelink between the relay node and the UE, or by the BS via the Uu link between the relay node and the BS. Different relay nodes may be configured with the same or different thresholds.

The present application provides various methods for the UE to acquire information (e.g., channel quality (especially the channel quality of Uu link), load, power consumption, etc.) about the one or more relay nodes.

In some embodiments, the UE may transmit an information request to the BS (e.g., via the Uu link between the UE and the BS) or to the one or more relay nodes (e.g., via the sidelink(s) between the UE and the relay node(s)) for acquiring the one or more information reports about the one or more relay nodes.

In some embodiments, the UE may transmit the information request to the BS or the one or more relay nodes when a first condition is fulfilled on the UE. In some embodiments, the first condition includes at least one of the following:
a data volume (e.g., PDCP data volume and/or RLC data volume) pending for transmission being equal to or larger than a selection triggering threshold;
the data volume pending for transmission being equal to or larger than an information request threshold: for example, the information request threshold may be less than the selection triggering threshold if both are configured;
a channel quality of a current activated path being equal to or lower than a channel quality threshold Q2: for example, the channel quality may include an RSRP or RSRQ measurement result; or
a channel quality deterioration of the current activated path being larger than a channel quality variation threshold.

In some embodiments, at least one of the selection triggering threshold, the information request threshold, the channel quality threshold Q2, or the channel quality variation threshold may be configured to the UE by the BS, or by the one or more relay nodes (for example, the BS may transmit the threshold(s) to a relay node and then the relay node may transmit the threshold(s) to the UE).

In some embodiments, the UE may transmit the information request via an RRC message, IE, MAC CE, or UCI.

In some embodiments, after reception of the information request, the BS or the one or more relay nodes may transmit the one or more information reports about the one or more relay nodes to the UE.

In some embodiments, the BS or the one or more relay nodes may transmit the one or more information reports about the one or more relay nodes to the UE periodically and/or for a predefined or preconfigured number of times in response to the information request.

In some embodiments, the BS or the one or more relay nodes may transmit the one or more information reports about the one or more relay nodes to the UE without receiving an information request from the UE. For example, the BS may transmit the one or more information reports to the UE according to its implementation. As another example, the BS or a relay node may transmit an information report about the relay node to the UE when a second condition is fulfilled on the relay node. In some embodiments, the second condition includes at least one of the following:
a channel quality of a Uu link between the relay node and the BS being lower than or higher than a channel quality threshold (e.g., the aforementioned channel quality threshold Q1);
a load on the Uu link being equal to or higher than at least one of one or more load thresholds (e.g., the aforementioned one or more load thresholds); or
a power consumption of the relay node being equal to or higher than at least one of one or more power consumption thresholds (e.g., the aforementioned one or more load thresholds).

In some embodiments, when the second condition is fulfilled on the relay node, the BS or the relay node may transmit an information report about the relay node to the UE periodically and/or for a predefined or preconfigured number of times.

In some embodiments, the UE may transmit a report ending indication to the BS (e.g., via the Uu link between the UE and the BS) or to the one or more relay nodes (e.g., via the sidelink(s) between the UE and the relay node(s)) for indicating the BS or the one or more relay nodes to stop transmission of the one or more information reports about the one or more relay nodes. In some embodiments, the UE may transmit the report ending indication via an RRC message, IE, MAC CE, or UCI.

As shown in FIG. 2, after receiving the one or more information reports in step 210, the UE may select at least one path for data transmission from the two or more paths between the UE and the BS based at least in part on the obtained one or more information reports in step 220. In some embodiments, the number of the at least one path selected for data transmission may be configured, indicated by a network, or predefined.

In some embodiments, the UE may be triggered to select the at least one path for data transmission when the aforementioned first condition is fulfilled.

For example, in some embodiments, when the data volume pending for transmission from the UE is equal to or larger than the selection triggering threshold, the path selection may be triggered. In some other embodiments, when the data volume pending for transmission from the UE is equal to or larger than the information request threshold, the UE may transmit an information request to the BS or the one or more relay nodes for acquiring the one or more information reports about the one or more relay nodes; then, when the data volume pending for transmission from the UE is increased up to the selection triggering threshold, the path selection may be triggered. In some other embodiments, the path selection may be triggered when the channel quality of a current activated path being equal to or lower than the channel quality threshold and/or the channel quality deterioration of the current activated path being larger than the channel quality variation threshold. In some other embodiments, the path selection may be triggered when the data volume pending for transmission from the UE is equal to or larger than the selection triggering threshold and the channel quality of the current activated path being equal to or lower than the channel quality threshold.

The present application provides various methods for the UE to select at least one path from the two or more paths based at least on the acquired information (e.g., channel quality (especially the channel quality of Uu link), load, power consumption, etc.) about the one or more relay node.

In some embodiments, the UE may perform the following operations to select the at least one path from the two or more paths:
determine, for each relay node of the one or more relay nodes, a minimum channel quality of a channel quality of a Uu link between the relay node and the BS and a channel quality of a sidelink between the relay node and the UE to be a channel quality of an indirect path corresponding to the relay node; and
select the at least one path from the two or more paths according to at least one of:
   a channel quality of the at least one direct path and one or more minimum channel qualities of the one or more relay nodes;
   one or more loads of the one or more relay nodes; or
   one or more power consumptions of the one or more relay nodes.

In some embodiments, the UE may select at least one path with the best channel quality(ies) among the two or more paths for data transmission.

In some embodiments, the UE may perform the following operations to select the at least one path from the two or more paths:
select relay node(s) from the one or more relay nodes, wherein for each of the selected relay node(s), a sidelink channel quality of the selected relay node is higher than a sidelink channel quality threshold, and a Uu link channel quality of the selected relay node is higher than a Uu channel quality threshold;
determine channel quality(ies) for selected indirect path(s) corresponding to the selected relay node(s) based on the sidelink channel quality(ies) and the Uu link channel quality(ies) of the selected relay node(s) (for example, the channel quality of an indirect path corresponding to a selected relay node may be a minimum or average of the sidelink channel quality and the Uu link channel quality of the selected relay node); and
select the at least one path from the two or more paths according to at least one of:
   channel quality(ies) of the selected indirect path(s) and a channel quality of the at least one direct path;
   load(s) of the selected relay node(s); or
   power consumption(s) of the selected relay node(s).

In some embodiments, the sidelink channel quality threshold and the Uu channel quality threshold may be configured or predefined.

In some embodiments, the UE may select at least one path with the best channel quality(ies) among the selected indirect path(s) and the at least one direct path for data transmission. In some embodiments, the UE may select at least one path with the best channel quality(ies) among the selected indirect path(s) for data transmission. In some embodiments, the UE may select at least one path with the best channel quality(ies) among the selected indirect path(s) when the selected relay node(s) has(have) a low load and/or a low power consumption.

In some embodiments, the UE may perform the following operations to select the at least one path from the two or more paths:
select relay node(s) from the one or more relay nodes, wherein for each of the selected relay node(s), a sidelink channel quality of the selected relay node is higher than a sidelink channel quality threshold;
determine the Uu link channel quality(ies) of the selected relay node(s) to be channel quality(ies) of selected indirect path(s) corresponding to the selected relay node(s); and
select the at least one path from the two or more paths according to at least one of:
   channel quality(ies) of the selected indirect path(s) and a channel quality of the at least one direct path;
   load(s) of the selected relay node(s); or
   power consumption(s) of the selected relay node(s).

In some embodiments, the sidelink channel quality threshold may be configured or predefined.

In some embodiments, the UE may select at least one path with the best channel quality(ies) among the selected indirect path(s) and the at least one direct path for data transmission. In some embodiments, the UE may select at least one path with the best channel quality(ies) among the selected indirect path(s) for data transmission. In some embodiments, the UE may select at least one path with the best channel quality(ies) among the selected indirect path(s) when the selected relay node(s) has(have) a low load and/or a low power consumption.

In some embodiments, the UE may perform the following operations to select the at least one path from the two or more paths:
determine, for each relay node of the one or more relay node, a channel quality average of a channel quality of a sidelink between the relay node and the UE and a channel quality of a Uu link between the relay node and the BS;
select the at least one path from the two or more paths according to at least one of:
   one or more channel quality averages of the one or more relay nodes and a channel quality of the at least one direct path;
   one or more loads of the one or more relay; or
   one or more power consumptions of the one or more relay nodes.

In some embodiments, the channel quality average may be a moving average or an arithmetic means.

In some embodiments, the UE may use the one or more channel quality averages of the one or more relay nodes as the channel quality(ies) of the corresponding indirect path(s), and select at least one path with the best channel quality(ies) among the indirect path(s) and the at least one direct path for data transmission. In some embodiments, the UE may select at least one path with the best channel quality(ies) among the indirect path(s) and the at least one direct path when the corresponding relay node(s) has(have) a low load and/or a low power consumption.

It is contemplated that there may be other criteria that may be considered for the UE to select the at least one path for data transmission, in addition to channel quality, load, and/or power consumption.

In some embodiments, the UE may consider that, for each relay node (or indirect path), the channel quality, load, power consumption, and/or other information report related content is not changed, changed slightly, or changed no larger than a certain threshold before the UE receives a new information report about the relay node from the relay node or from the BS.

For example, the UE receives information report A about a relay node at slot a, and receives information report B about the relay node at slot b. There is one or more occasions between slot a and slot b where the UE expects to receive information report(s) about the relay node, while the UE does not receive any expected information report(s) about the relay node between slot a and slot b. It may be due to certain transmission failure, or due to that the relay node or the BS does not transmit any information report, e.g., because the channel quality, load, power consumption, or other report related content is not changed, changed slightly, or changed no larger than a certain threshold between slot a and slot b. In either case, the UE may consider that information report A is valid till information report B is received in slot b.

It is contemplated that in some embodiments, the selected at least one path may include at least one direct path; and in some other embodiments, the selected at least one path does not include any direct path.

Although only one BS is considered in the above embodiments, it is contemplated that all of the embodiments in the present disclosure can also be applied to the UE supporting a multi-path split bearer which can be configured with two or more paths between the UE and one or more BSs.

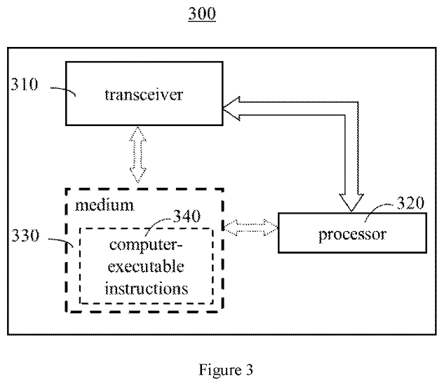

FIG. 3 illustrates a simplified block diagram of an exemplary apparatus 300 according to some embodiments of the present disclosure.

In some embodiments, the apparatus 300 may be or include at least part of a UE which is capable of performing the aforementioned methods (e.g., method 200) performed by a UE supporting multi-path split bearer for data transmission.

In some embodiments, the apparatus 300 may be or include at least part of a BS which is capable of performing the aforementioned methods performed by a BS supporting multi-path split bearer for data transmission.

In some embodiments, the apparatus 300 may be or include at least part of a relay node which is capable of performing the aforementioned methods performed by a relay node supporting multi-path split bearer for data transmission.

As shown in FIG. 3, the apparatus 300 may include at least a transceiver 310 and a processor 320 coupled to transceiver 310. In some embodiments, the transceiver 310 may include a transmitter and a receiver integrated together. In some embodiments, the transceiver 310 may include a transmitter and a receiver which are separated from each other. In some embodiments, the transceiver 310 may be a wireless transceiver.

In some embodiments, the apparatus 300 may include a non-transitory computer-readable medium 330 with computer-executable instructions 340 stored thereon. The non-transitory computer-readable medium 330 may be coupled to the processor 320 and the transceiver 310, and the computer-executable instructions 340 may be configured to be executable by the processor 320. In some embodiments, the transceiver 310, the non-transitory computer-readable medium 330, and the processor 320 may be coupled to each other via one or more local buses.

Although in FIG. 3, elements such as the transceiver 310, the non-transitory computer-readable medium 330, and the processor 320 are described in the singular, the plural is contemplated unless limitation to the singular is explicitly stated. In certain embodiments of the present disclosure, the apparatus 300 may further include other components for actual usage.

In various example embodiments, the processor 320 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 320 may also include at least one other circuitry or element not shown in FIG. 3.

In various example embodiments, the non-transitory computer-readable medium 330 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 330 may include, but is not limited to, an electric, a magnetic, an optical, an electromagnetic, an infrared, or a semiconductor system, apparatus, or device or any combination of the above.

Further, in various example embodiments, the apparatus 300 may also include at least one other circuitry, element, and interface, for example antenna element, and the like.

According to some embodiments, the apparatus 300 is a UE. The transceiver 310 and the processor 320 may be configured to perform operations in any methods described above which are performed by a UE. For example, the transceiver 310 may be configured to receive one or more information reports about one or more relay nodes from a BS or the one or more relay nodes, and the processor 320 may be configured to select at least one path for data transmission from two or more paths between the UE and the BS based at least in part on the obtained one or more information reports, wherein the two or more paths include one or more indirect paths corresponding to the one or more relay nodes and at least one direct path between the UE and the BS.

According to some embodiments, the apparatus 300 is a BS. The transceiver 310 and the processor 320 may be configured to perform operations in any methods described above which are performed by a BS. For example, the transceiver 310 may be configured to transmit an information report about a relay node to a UE for the UE to select at least one path for data transmission from two or more paths between the UE and the BS, wherein the two or more paths includes an indirect path corresponding to the relay node and at least one direct path between the UE and the BS.

According to some embodiments, the apparatus 300 is a relay node. The transceiver 310 and the processor 320 may be configured to perform operations in any methods described above which are performed by a BS. For example, the transceiver 310 may be configured to transmit an information report about the relay node for a UE to select at least one path for data transmission from two or more paths between the UE and a BS, wherein the two or more paths include an indirect path corresponding to the relay node and at least one direct path between the UE and the BS.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

What is claimed is:

1. A user equipment (UE) for wireless communication, comprising:
at least one memory; and
at least one processor coupled with the at least one memory and operable to cause the UE to:
receive one or more information reports about one or more relay nodes from a base station (BS) or the one or more relay nodes; and
select at least one path for data transmission from two or more paths between the UE and the BS based at least in part on the received one or more information reports, wherein the two or more paths include one or more indirect paths corresponding to the one or more relay nodes and at least one direct path between the UE and the BS.

2. The UE of claim 1, wherein the at least one processor is operable to cause the UE to select the at least one path for data transmission when a first condition is fulfilled, wherein the first condition includes at least one of:
a data volume pending for transmission being equal to or larger than a selection triggering threshold;
the data volume pending for transmission being equal to or larger than an information request threshold;
a channel quality of a current activated path being equal to or lower than a first channel quality threshold; or
a channel quality deterioration of the current activated path being larger than a channel quality variation threshold.

3. The UE of claim 2, wherein the at least one processor is operable to cause the UE to:
transmit an information request to the BS or the one or more relay nodes when the first condition is fulfilled, wherein the one or more information reports are received in response to the information request.

4. The UE of claim 1, wherein the at least one processor is operable to cause the UE to transmit a report ending indication to the BS or to the one or more relay nodes for indicating to stop transmission of the one or more information reports about the one or more relay nodes.

5. The UE of claim 1, wherein the at least one processor is operable to cause the UE to transmit at least one threshold to each relay node of the one or more relay nodes for triggering the relay node to transmit an information report about the relay node when a second condition is fulfilled, wherein the at least one threshold comprises one or more of:
a second channel quality threshold;
one or more load thresholds; or
one or more power consumption thresholds.

6. The UE of claim 1, wherein each of the one or more information reports includes at least one of:
a channel quality of a Uu link between an associated relay node and the BS;
a channel quality indication for indicating whether the channel quality of the Uu link is lower than or higher than a second channel quality threshold;
a load on the Uu link;
a load indication for indicating whether the load on the Uu link is lower than, equal to, or higher than at least one load threshold;
a power consumption of the associated relay node; or
a power consumption indication for indicating whether the power consumption of the associated relay node is lower than, equal to, or higher than at least one power consumption threshold.

7. The UE of claim 1, wherein to select the at least one path from the two or more paths, the at least one processor is operable to cause the UE to:
determine, for each relay node of the one or more relay nodes, a minimum channel quality of a channel quality of a Uu link between the relay node and the BS and a channel quality of a sidelink between the relay node and the UE to be a channel quality of an indirect path corresponding to the relay node; and
select the at least one path from the two or more paths according to at least one of:
a channel quality of the at least one direct path and one or more minimum channel qualities of the one or more relay nodes;
one or more loads of the one or more relay nodes; or
one or more power consumptions of the one or more relay nodes.

8. The UE of claim 1, wherein to select the at least one path from the two or more paths, the at least one processor is operable to cause the UE to:
select at least one relay node from the one or more relay nodes, wherein for each of the selected at least one relay node, a sidelink channel quality of the selected at least one relay node is higher than a sidelink channel quality threshold, and a Uu link channel quality of the selected at least one relay node is higher than a Uu channel quality threshold;
determine at least one channel quality for one or more selected indirect paths corresponding to the selected at least one relay node based at least in part on at least one sidelink channel quality and at least one Uu link quality of the selected at least one relay node; and
select the at least one path from the two or more paths according to at least one of:
at least one channel quality of the one or more selected indirect paths and a channel quality of the at least one direct path;
one or more loads of the selected at least one relay node; or
power consumption associated with the selected at least one relay node.

9. The UE of claim 1, wherein to select the at least one path from the two or more paths, the at least one processor is operable to cause the UE to:
select at least one relay node from the one or more relay nodes, wherein for each of the selected at least one relay node, a sidelink channel quality of the selected at least one relay node is higher than a sidelink channel quality threshold;
determine at least one Uu link channel quality of the selected at least one relay node to be at least one channel quality of one or more selected indirect paths corresponding to the selected at least one relay node; and
select the at least one path from the two or more paths according to at least one of:
at least one channel quality of the one or more selected indirect paths and a channel quality of the at least one direct path;
one or more loads of the selected at least one relay node; or
power consumption associated with the selected at least one relay node.

10. The UE of claim 1, wherein to select the at least one path from the two or more paths, the at least one processor is operable to cause the UE to:
determine, for each relay node of the one or more relay nodes, a channel quality average of a channel quality of a sidelink between the relay node and the UE, and a channel quality of a Uu link between the relay node and the BS; and
select the at least one path from the two or more paths according to at least one of:
one or more channel quality averages of the one or more relay nodes and a channel quality of the at least one direct path;
one or more loads of the one or more relay nodes; or
one or more power consumptions of the one or more relay nodes.

11. A base station (BS) for wireless communication, comprising:
at least one memory; and
at least one processor coupled with the at least one memory and operable to cause the BS to:
transmit an information report about a relay node to a user equipment (UE) for the UE to select at least one path for data transmission from two or more paths between the UE and the BS, wherein the two or more paths include an indirect path corresponding to the relay node and at least one direct path between the UE and the BS.

12. The BS of claim 11, wherein the at least one processor is operable to cause the BS to transmit at least one threshold to the UE for triggering the UE to select the at least one path for data transmission from the two or more paths when a first condition is fulfilled, wherein the at least one threshold comprises one or more of:
a selection triggering threshold;
an information request threshold;
a first channel quality threshold; or
a channel quality variation threshold.

13. The BS of claim 12, wherein the first condition includes at least one of:
a data volume pending for transmission at the UE being equal to or larger than the selection triggering threshold;
the data volume pending for transmission at the UE being equal to or larger than the information request threshold;
a channel quality of a current activated path being equal to or lower than the first channel quality threshold; or
a channel quality deterioration of the current activated path being larger than the channel quality variation threshold.

14. A relay node for wireless communication, comprising:
at least one memory; and
at least one processor coupled with the at least one memory and operable to cause the relay node to:
transmit an information report about the relay node for a user equipment (UE) to select at least one path for data transmission from two or more paths between the UE and a base station (BS), wherein the two or more paths include an indirect path corresponding to the relay node and at least one direct path between the UE and the BS.

15. The relay node of claim 14, wherein the at least one processor is operable to cause the relay node to:
receive an information request from the UE; and
transmit the information report to the UE in response to the information request.

16. A method performed by a user equipment (UE), the method comprising:
receiving one or more information reports about one or more relay nodes from a base station (BS) or the one or more relay nodes; and
selecting at least one path for data transmission from two or more paths between the UE and the BS based at least in part on the received one or more information reports, wherein the two or more paths include one or more indirect paths corresponding to the one or more relay nodes and at least one direct path between the UE and the BS.

17. The method of claim 16, further comprising selecting the at least one path for data transmission when a first condition is fulfilled, wherein the first condition includes at least one of:
a data volume pending for transmission being equal to or larger than a selection triggering threshold;
the data volume pending for transmission being equal to or larger than an information request threshold;
a channel quality of a current activated path being equal to or lower than a first channel quality threshold; or
a channel quality deterioration of the current activated path being larger than a channel quality variation threshold.

18. The method of claim 17, further comprising transmitting an information request to the BS or the one or more relay nodes when the first condition is fulfilled, wherein the one or more information reports are received in response to the information request.

19. The method of claim 16, further comprising transmitting a report ending indication to the BS or to the one or more relay nodes for indicating to stop transmission of the one or more information reports about the one or more relay nodes.

20. The method of claim 16, further comprising transmitting at least one threshold to each relay node of the one or more relay nodes for triggering the relay node to transmit an information report about the relay node when a second condition is fulfilled, wherein the at least one threshold comprises one or more of:
a second channel quality threshold;
one or more load thresholds; or
one or more power consumption thresholds.
